(19) United States
(12) Patent Application Publication
(10) Pub. No.: US 2015/0232178 A1
(43) Pub. Date: Aug. 20, 2015

(54) AIRCRAFT FOR VERTICAL TAKE-OFF AND LANDING WITH TWO WING ARRANGEMENTS

(71) Applicant: Johannes REITER, (US)

(72) Inventor: Johannes Reiter, Laakirchen (AT)

(21) Appl. No.: 14/378,604

(22) PCT Filed: Feb. 13, 2013
(86) PCT No.: PCT/EP2013/052903

§ 371 Date: Aug. 13, 2014

(30) Foreign Application Priority Data
Feb. 13, 2012 (GB) 1202441.0
Aug. 21, 2012 (GB) 1214887.0

(51) Int. Cl. B64C 29/00; B64C 37/00; B64C 3/38

(52) U.S. Cl. CPC B64C 29/0033; B64C 3/38; B64C 37/00

(57) ABSTRACT

The present invention relates to an aircraft comprising a fuselage (100) comprising a fuselage axis (101), a first wing arrangement (110) and a second wing arrangement (120). The first wing arrangement (110) is mounted to the fuselage (100) such that the first wing arrangement (110) is tiltable around a first longitudinal wing axis (111) of the first wing arrangement (110) and such that the first wing arrangement (110) is rotatable around the fuselage axis (101). The second wing arrangement (120) comprises at least one propulsion unit (122), wherein the second wing arrangement (120) is mounted to the fuselage (100) such that the second wing arrangement (120) is tiltable around a second longitudinal wing axis (121) of the second wing arrangement (120) and such that the second wing arrangement (120) is rotatable around the fuselage axis (101). The first wing arrangement (110) and the second wing arrangement (120) are adapted in such a way that, in a fixed-wing flight mode, the first wing arrangement (110) and the second wing arrangement (120) do not rotate around the fuselage axis (101). The first wing arrangement (110) and the second wing arrangement (120) are further adapted in such a way that, in a hover flight mode, the first wing arrangement (110) and the second wing arrangement (120) are tilted around the respective first longitudinal wing axis (111) and the respective second longitudinal wing axis (121) with respect to its orientations in the fixed-wing flight mode and that the first wing arrangement (110) and the second wing arrangement (120) rotate around the fuselage axis (101).

### FIELD OF THE INVENTION

The present invention relates to an aircraft for vertical take-off and landing and to a method for operating an aircraft for vertical take-off and landing.

### BACKGROUND OF THE INVENTION

It is an aim to have aircraft that are able to start and land without a runway for example. Hence, in the past several developments for so called Vertical Take-Off and Landing aircraft (VTOL) have been done. Conventional VTOL-Aircraft need a vertical thrust for generating the vertical lift. Thrust for vertical take-off may be produced by big propellers or jet engines. Propellers may have the disadvantage in travel flight of an aircraft due to a high drag.

An efficient solution for a hover flight capable aircraft is performed by helicopters, using e.g. a big wing area. In a known system, an aircraft comprises an engine for vertical lifting the aircraft (e.g. a propeller) and e.g. a further engine for generating the acceleration of the aircraft in a travel mode up to a desired travelling speed.

In the hover flight mode, the rotating wings or blades of an aircraft (e.g. a helicopter) generate the vertical lift. The rotating wings comprise a chord line, wherein an angle between the chord line and the streaming direction of the air may be called angle of attack. A higher angle of attack generates a higher lift and a lower angle of attack generates a lower lift but also less drag. In order to achieve a higher efficiency of the rotating wings it may be helpful to adjust the angle of attack. Thus, the wings may be tilted around its longitudinal axis.

### OBJECT AND SUMMARY OF THE INVENTION

It may be an object of the present invention to provide an efficient aircraft for vertical take-off and landing with proper flight conditions.

This object may be solved by an aircraft for vertical take-off and landing and by a method for operating such an aircraft according to the independent claims.

According to a first aspect of the present invention, an aircraft is presented. The aircraft comprises a fuselage comprising a fuselage axis, a first wing arrangement and a second wing arrangement. The first wing arrangement is mounted to the fuselage such that the first wing arrangement is tiltable around a first longitudinal wing axis of the first wing arrangement and such that the first wing arrangement is rotatable around the fuselage axis.

The second wing arrangement comprises at least one propulsion unit. The second wing arrangement is mounted to the fuselage such that the second wing arrangement is tiltable around a second longitudinal wing axis of the second wing arrangement and such that the second wing arrangement is rotatable around the fuselage axis.

The first wing arrangement and the second wing arrangement are adapted in such a way that in a fixed wing mode, the first wing arrangement and the second wing arrangement do not rotate around the fuselage axis.

Furthermore, the first wing arrangement and the second wing arrangement are further adapted in such a way that, in a hover flight mode, the first wing arrangement and the second wing arrangement are tilted around the respective first longitudinal wing axis and the respective second longitudinal wing axis with respect to its orientations in the fixed wing flight mode and that the first wing arrangement and the second wing arrangement rotate around the fuselage axis.

According to a further aspect of the present invention, a method for controlling the above-described aircraft for vertical take-off and landing is presented. According to the method, the aircraft is converted in a fixed wing flight mode by arranging a first wing arrangement, the second wing arrangement and the fuselage with respect to each other such that the fixed wing flight is enabled. Furthermore, the aircraft is converted in the hover flight mode by tilting the first wing arrangement around the first longitudinal wing axis, by tilting the second wing arrangement around the second longitudinal wing axis and by rotating the first wing arrangement and the second wing arrangement around a fuselage axis for enabling the hover flight.

The respective wing arrangements comprise respective longitudinal wing axes, wherein the respective longitudinal wing axes are the respective axes around which the respective wing arrangement is tiltable with respect to the fuselage. The longitudinal wing axes may be defined by the run of a respective main wing spar or by a respective bolt that connects for example a respective wing root of the respective wing arrangement with the fuselage. The respective wing arrangement is mounted at the wing root to the fuselage, wherein at an opposite end of the respective wing arrangement with respect to the respective wing root a wing tip is defined, which is a free end of the respective wing arrangement. The respective longitudinal wing axis may be parallel e.g. with a leading edge or a trailing edge of the respective wing arrangement. Moreover, the respective longitudinal wing axis may be an axis that is approximately perpendicular to a fuselage axis.

Each of the respective wing arrangements may comprise one, two or a plurality of wings. Each wing may comprise an aerodynamical wing profile comprising a respective leading edge where the air impinges and a respective trailing edge from which the air streams away from the wing. A chord line of the wing arrangement and the wings, respectively, refers to an imaginary straight line connecting the leading edge and the trailing edge within a cross-section of an airfoil. The chord length is the distance between the trailing edge and the leading edge. Specifically, the wings which comprise at least one propulsion unit and which rotate in the hover flight mode may be assigned to the second wing arrangement and the wings which do not comprise a propulsion unit and which rotate in the hover flight mode may be assigned to the first wing arrangement.

The fuselage may comprise provision for supplying sensors, such as cameras or measurement equipment for physical parameters (e.g. temperature, pressure). Furthermore, a cockpit for a pilot of the aircraft may be installed in the fuselage. Also control devices are installed in the fuselage. Specifically, remote controlled devices for remotely controlling the aircraft are installed in the fuselage for enabling an unmanned flight of the aircraft.

The fuselage describes a main body of the aircraft, wherein in general the centre of gravity of the aircraft is located inside the area of the fuselage. The fuselage may be in one exemplary embodiment of the present invention a small body to which the respective first and second wing arrangements are rotatably mounted, so that the aircraft may be defined as a so-called flying wing aircraft. In particular, the fuselage may be a section of the wing arrangements and the fuselage may comprise a length equal to the chord line (e.g. a width) of a respective wing of a respective wing arrangement. Alternatively, the fuselage comprises a length that is longer than e.g. the chord line (e.g. the width) of the respective wing of the respective wing arrangement. The fuselage comprises a nose and a tail section.

The fuselage axis is the rotary axis around which the respective wing arrangement may rotate, in particular around the fuselage. The fuselage axis may be in an exemplary embodiment the longitudinal fuselage symmetry axis of the fuselage. In an exemplary embodiment, the fuselage axis may comprise an angle between the longitudinal fuselage symmetry axis and may thus run non-parallel to the longitudinal fuselage symmetry axis. Alternatively, it also could possibly run in any other axis.

The aircraft according to the present invention may be a manned aircraft or an unmanned aerial vehicle (UAV) or remotely piloted aerial vehicle (RPAV). The aircraft may be e.g. a drone that comprises for example a wing span of approximately 1 m to 4 m (meter) with a weight of approximately 4 kg to 6 kg (kilograms). In another exemplary embodiment, the aircraft according to the present invention may have a weight up to 40 Tons and beyond. The span width of the first wing arrangement of such a heavy configuration may be longer than 25 meter, in particular longer than 30 meter.

In the fixed-wing flight mode, the first and second wing arrangements are fixed to the fuselage without having a relative motion between the wing arrangements and the fuselage, so that by a forward motion of the aircraft trough the air lift is generated by the wing arrangements, in particular by the first wing arrangement.

In the hover flight mode, the first and second wing arrangements rotate around the fuselage or any similar axis, so that due to the rotation of the first and second wing arrangements through the air a lift is generated even without a relative movement of the aircraft through the air. Hence, by rotating the first and second wing arrangements through the air, a hover flight mode is achievable, e.g. such as a helicopter's. Moreover, if the first and second wing arrangements rotate in the hover flight mode around the fuselage axis, a stabilizing moment (e.g. a gyroscopic moment, i.e. a conservation of angular momentum) for stabilizing the aircraft is generated. In a fixed-wing flight mode, the wing arrangement is fixed to the fuselage without having a relative motion between the wing arrangement and the fuselage, so that by a forward motion of the aircraft through the air the lift is generated by the wing arrangement by a forward movement of the wing arrangement through the air.

The respective wing arrangements may be fixed to the fuselage such that the wing arrangements are not rotatable relative to the fuselage. Hence, in the hover flight mode, both, the respective wing arrangements and the fuselage rotate around the fuselage axis for generating lift. In an alternative embodiment, the respective wing arrangements are mounted to the fuselage such that the respective wing arrangements rotate around the fuselage axis relatively to the fuselage, so that in the hover flight mode the wing may rotate for generating lift and the fuselage may not rotate around the fuselage axis. Moreover, if the first and second wing arrangements rotate in the hover flight mode, a stabilizing moment (e.g. a gyroscopic moment, i.e. a conservation of angular momentum) for stabilizing the aircraft is generated.

Hence, by the present invention, a vertical take-off and landing aircraft is presented which combines the concept of a fixed-wing flight mode aircraft and a hover flight mode aircraft. Hence, both advantages of each flight mode may be combined. For example, a fixed-wing flight aircraft is more efficient during the cruise flight, i.e. when the aircraft moves through the air. On the other side, in the hover flight mode of the aircraft, the first and second wing arrangements rotate such as wings or blades of a helicopter, so that the wing itself generates the lifting force in the hover flight mode. This is more efficient due to the large wing length in comparison to lift generating propulsion engines in known VTOL aircraft. For example, known VTOL aircraft generate the lift by engine power.

The propulsion unit may be a jet engine, a turbo jet engine, a turbo fan, a turbo prop engine, a prop fan engine, a rotary engine, rocket propulsion engines and/or a propeller engine. A driving shaft of a propeller piston engine and/or a turbine shaft of a jet engine may define a rotary axis, for example. The propulsion unit may pivotable around the longitudinal wing axis with respect to and relative to the second wing arrangement or together with a tilting of the second wing arrangement. The propulsion units (Le. the engines) may be installed in a different position to the propelling medium (e.g.

propeller) and connected with a shaft and gearbox. So, the best aerodynamic position for the propelling medium can be used, while having the lowest possible centrifugal force effects (hence the propulsion unit is usually positioned as far inside of the wing as possible) on the propulsion unit. Propulsion units can also be installed in the fuselage and the thrust is transported to the wings via a piping system then. Moreover, the propulsion unit may be driven by electrical power or by fuel, such as hydrogen or kerosene. The necessary fuel tank or batteries may be installed in the fuselage or in the respective wing arrangement. Between the battery or the tank and the propulsion devices, a supply line system may be installed, so that in particular power or fuel may be directed from the fuel tank or the battery to the respective propulsion device. Hence, the batteries or the fuel tanks may be installed to desired locations spaced from the propulsion units, so that a beneficial balance point adjustment of the aircraft may be achieved.

In an exemplary embodiment, the propulsion unit may be adapted for generating a thrust of 3 kg to 5 kg (kilograms). In the hover flight mode, approximately 25 kg are liftable. The aircraft for vertical take-off and landing may thus have a thrust-to-weight ratio of approximately 0.2 to 0.4, preferably 0.3.

The propulsion unit, which is fixed to the second wing arrangement, drives the aircraft through the air in the fixed wing mode and provides a driving torque which rotates the first and second wing arrangements around the fuselage axis in the hover flight mode. Therefore, the second wing arrangement and the first wing arrangement are coupled in such a way, that a rotation of the second wing arrangement causes a respective rotation of the first wing arrangement around the fuselage axis or backwards. In particular, the propulsion unit may be attached at respective free ends of the second wing arrangement or between a root end of the second wing arrangement and the free end of the second wing arrangement. In an exemplary embodiment, the first wing arrangement is free of any propulsion units, i.e. the first wing arrangement does not comprise any propulsion units. Any numbers of propulsion units can be used.

By the present invention, an aircraft is described which comprises two separate wing arrangements, in particular a first wing arrangement and a second wing arrangement, wherein (only) to the second wing arrangement at least one propulsion unit is attached or vice versa. Hence, the first wing arrangement may be free of any propulsion units for driving the aircraft in the fixed wing mode and the hover flight mode. This has the positive effect, that the structure of the first wing arrangement is not stressed by the load of the propulsion unit, and that the first wing arrangement may comprise a large aerodynamical area for generating lift and hence a larger first wing span in comparison to the second wing arrangement, which is stressed by the load of the propulsion unit, for example. In particular, the second wing arrangement may be formed and optimized for carrying the at least one propulsion unit, wherein the structure of the first wing arrangement may be optimized for generating lift.

By this configuration, in hover flight mode, due to the positioning of the second wing arrangement in relation to the first wing arrangement, a stabilizing gyro spin is achieved, making the rotor in flight stable.

Hence, by the above-described arrangement with the first wing arrangement and the second wing arrangement, the first wing arrangement may be optimized for generating lift instead of providing carrying means for the propulsion unit, so that a more efficient vertical take-off and landing aircraft is achieved. Additionally, because the second wing arrangement comprises at least one propulsion unit and because the first wing arrangement may be free of any propulsion units, in the fixed wing flight mode the propulsion units do not disturb the flow of the air around the first wing arrangement so that turbulences caused by the propulsion units do not affect the streaming of air around the first wing arrangement.

According to a further exemplary embodiment, the first wing arrangement comprises a first wing span and the second wing arrangement comprises a second wing span, wherein the first wing span is longer than the second wing span. In particular, the first wing arrangement comprises a larger aerodynamical area for generating lift than the second wing arrangement for generating longitudinal stability. The wing span of the first and second wing arrangement may be defined by the distance of the respective tip ends of the respective wing arrangements in the fixed wing flight mode.

Particularly, the second wing span may be shorter than approximately the half of the first wing span, in particular approximately shorter than ⅓ of the first wing span.

According to a further exemplary embodiment, the first wing arrangement and/or the second wing arrangement comprise controllable control surfaces, such that the aircraft is controllable. In particular, the second wing arrangement comprises controllable control surfaces such that the second wing arrangement is adapted for the use as a rudder in the fixed wing mode.

In particular, the second wing arrangement may be mounted to the fuselage in such a way, that the complete aerodynamical area of the second wing arrangement may function as a rudder. Hence, the complete aerodynamical surface of the second wing arrangement may function as a control surface and the complete second wing arrangement may be pivoted with respect to the fuselage in order to control the flight of the aircraft.

Moreover, the respective wing arrangements wing may comprise control surfaces, such as an aileron or a rudder, for example. Hence, in the fixed wing mode, the first wing arrangement and the second wing arrangement may be controlled in such a way that the areodynamical surfaces of the first wing arrangement and the second wing arrangement may be used as control surfaces, such as aileron surfaces.

According to a further exemplary embodiment, the first wing arrangement is mounted to the fuselage at a first mounting location and wherein the second wing arrangement is mounted to the fuselage at a second mounting location.

Specifically, the first mounting location and the second mounting location are spaced along the fuselage axis. Alternatively, the first mounting location and the second mounting location are not spaced along the fuselage axis.

According to a further exemplary embodiment, the aircraft further comprises a third wing arrangement. The third wing arrangement is mounted to the fuselage at a third mounting location, wherein the third mounting location is spaced to the first mounting location and the second mounting location along the fuselage axis.

In an exemplary embodiment of the aircraft, the centre of gravity lies approximately in the centre of area of the wings so that by forward swept wings a centre of gravity more forward can be positioned, compared to a straight rectangular wing, for example (in a canard configuration). This is advantageous since in the hover flight mode, the centre of gravity should be as much forward as possible, i.e. in the hover flight as much downward, as possible. Hence, for vertical take off and landing in the hover flight mode, the rotor is as far from the ground as possible (in the most opposite position of the fuselage to the ground, that is the back), and in the fixed wing flight mode, the centre of gravity fits to the canard wing configuration appropriately.

The third wing arrangement may provide stabilizing functions for the aircraft. For example, if the first wing arrangement and the second wing arrangement are mounted to the fuselage spaced from the centre of gravity of the aircraft along a first direction along the fuselage axis, the third wing arrangement may be mounted to the fuselage spaced from the centre of gravity in an opposite second direction along the fuselage axis with respect to the first direction. Hence, in particular in the fixed wing flight mode, a stabilized flight may be achieved. The third wing arrangement may be fixed to the fuselage in such a way that the third wing arrangement does not rotate around the fuselage axis in the hover flight mode.

According to a further exemplary embodiment, the fuselage comprises a first fuselage part and a second fuselage part. The first fuselage part and the second fuselage part are arranged one after another along the fuselage axis, wherein the first wing arrangement and the second wing arrangement are mounted to the first fuselage part.

Specifically, according to a further exemplary embodiment, the first fuselage part is rotatable around the fuselage axis with respect to the second fuselage part. Hence, in the first fuselage part, all equipments which rotate together with the respective first and second wing arrangements in the hover flight mode may be stored and mounted. To the second fuselage part, all equipments which need a stable and non-rotating position, such as cameras for observing the ground or a cockpit for a pilot, may be arranged in the second fuselage part.

The first fuselage part and the second fuselage part may be coupled for example by a roller bearing, such that the first fuselage part is rotatable around the fuselage axis with respect to the second fuselage part. In particular, the first fuselage part may overlap in a transition section the second fuselage part, wherein in the transition section a roller bearing between the first and second fuselage part is arranged.

According to a further exemplary embodiment, the fuselage, and in particular the second fuselage part, comprises a landing gear, in particular an extendable and foldable landing gear. By the landing gear, such as landing pillars or landing wheels, the aircraft stands on a ground.

For example, when starting the aircraft in the hover flight mode, the first fuselage part may rotate around the fuselage axis, such that the first wing arrangement and the second wing arrangement rotates around the fuselage axis so that a lift is generated. On the other side, the second fuselage part stands non-rotatable on the ground on the landing gear and/or the third wing arrangement until sufficient lift for lifting the aircraft is generated.

According to a further exemplary embodiment, the aircraft further comprises a first hinge device and a second hinge device. The first wing arrangement is mounted to the fuselage by the first hinge device and the second wing arrangement is mounted to the fuselage by the second hinge device, such that the first wing arrangement and the second wing arrangement are foldable between an operating mode of the aircraft and the transportation mode of the aircraft. Furthermore, the third wing arrangement may be coupled to the fuselage by a third hinge device.

For example, the first wing arrangement and the second wing arrangement are foldable and extendable by the coupling with the respective first hinge device and the respective second hinge device. In the transportation mode, the first wing arrangement and the second wing arrangement may be folded so that the aircraft is packed and requires a reduced storage space. Hence, the aircraft may be transported in a backpack or in a small container for example.

At the field of operation, the aircraft and in particular the first wing arrangement and the second wing arrangement may be extended so that the full first and second wing span of the respective wing arrangement is extended. Hence, by the hinge devices, a portable aircraft with reduced storage space is achieved.

According to a further exemplary embodiment, the first wing arrangement comprises a first wing and a further first wing. The first longitudinal wing axis is split in a first longitudinal wing axis section and a further first longitudinal wing axis section. The first wing extends along the first longitudinal wing axis section and the further first wing extends along the further first longitudinal wing axis section from the fuselage. The first wing is tiltable with the first rotational direction around the first longitudinal wing axis section and the further first wing is tiltable with a further first rotational direction around the further first longitudinal wing axis section.

According to a further exemplary embodiment, the first rotational direction differs to the further first rotational direction.

Accordingly, according to a further exemplary embodiment, the second wing arrangement comprises a second wing and a further second wing. The second longitudinal wing axis is split in a second longitudinal wing axis section and a further second longitudinal wing axis section. The second wing extends along the second longitudinal wing axis section and the further second wing extends along the further second longitudinal wing axis section from the fuselage. The second wing is tiltable with the second rotational direction around the second longitudinal wing axis section and the further second wing is tiltable with a further second rotational direction around the further second longitudinal wing axis section. According to a further exemplary embodiment, the second rotational direction differs to the further second rotational direction.

For example, in the hover flight mode, the first longitudinal wing axis section and the further first longitudinal wing axis section are oriented substantially parallel. In the fixed-wing flight mode, the first longitudinal wing axis section and the further first longitudinal wing axis section may also extend parallel to each other. In an alternative embodiment the first longitudinal wing axis section and the further first longitudinal wing axis section may run unparallel between each other, so that an angle between the first longitudinal wing axis section and the further first longitudinal wing axis section is provided. If the first longitudinal wing axis section and the further first longitudinal wing axis section comprise an angle between each other, the first wing and the further first wing may comprise a wing sweep, in particular a forward swept, a swept, an oblique wing or a variable swept (swing wing).

In particular, if the first wing extends from one side of the fuselage and the further first wing extends from the opposed side of the fuselage, and the first wing and the further first wing rotates around the fuselage axis, it may be necessary that the respective wing edges, i.e. the leading edges of the wings, are moved through the air such that the air impacts (attacks) at the leading edge instead of the trailing edge, so that lift is generated by the wing profile. Hence, for the transformation of the aircraft from the fixed-wing flight modus to the hover flight modus, the first wing may rotate around its first wing longitudinal axis section around approximately 60° (degrees) to approximately 120°, in particular approximately 90°, in the first rotational direction and the further first wing may be tilted around approximately 60° (degrees) to approximately 120°, in particular approximately 90°, around the further first wing longitudinal axis section in the further first rotational direction, which is an opposed direction with respect to the first rotational direction. In an alternative embodiment it is as well possible that the first rotational direction and the second rotational direction are equal.

In a further exemplary embodiment, the aircraft may comprise further wing arrangements, e.g. a fourth or a sixths wing arrangement. The further wing arrangement may be retractable for example. In the fixed-wing mode, the further wing arrangements may form a double-decker, for example.

According to a further exemplary embodiment, the aircraft comprises a sleeve to which the first wing arrangement and/or the second wing arrangement is/are mounted. The sleeve is slidably mounted to the fuselage such that the sleeve is slideable along a surface (i.e. along a centre axis/fuselage axis of the fuselage) of the fuselage and such that the sleeve is rotatable around the fuselage axis. Furthermore, a further sleeve may be attached to the fuselage as described above, wherein to each of the sleeves a respective wing arrangement may be mounted.

Hence, the respective wing arrangements are attached by the sleeve(s) to the fuselage. By using the sleeve, the respective wing arrangements may e.g. surround the fuselage and thus not run through the fuselage, e.g. for fixing purposes. Hence, a relative motion between the respective wing arrangements and the fuselage by using the sleeve is achieved. The respective wing arrangements are rotatably fixed to the circumferential surface of the fuselage by the sleeve. The sleeve may be a closed or open sleeve to which the respective wing arrangements are attached, e.g. at the outer surface of the sleeve. Furthermore, the sleeve is slideably clamped (e.g. by its inner surface) to the outer surface of the fuselage, wherein between the sleeve and the fuselage a slide bearing is formed. Besides the slide bearing, the sleeve and the outer surface of the fuselage may be adapted to form e.g. a ball bearing, so that abrasion is reduced.

Between the inner surface of the sleeve and the outer surface of the fuselage, a bearing ring may be interposed which is non-rotatably fixed either to the fuselage or to the respective wing arrangements. For example, the sleeve may be slidable with respect to the bearing ring, wherein the bearing ring is fixed to the fuselage without being slidable.

Alternatively, according to a further exemplary embodiment, the bearing ring is slidably mounted to the fuselage such that the bearing ring is slideable along a surface of the fuselage and such that the bearing ring is rotatable around the further rotary axis. The sleeve may rotate together with the bearing ring around the further rotary axis.

Further alternatively, according to a further exemplary embodiment, the bearing ring is rotatably mounted to the fuselage such that the bearing ring is rotatable around the fuselage axis of the fuselage but wherein the bearing ring is mounted to the fuselage such that the bearing ring is not moveable along the fuselage axis. The sleeve to which the respective wing arrangements are mounted is moveable with respect to the bearing ring along the fuselage axis and the sleeve rotates together with the bearing ring around the fuselage axis.

The bearing ring may comprise roller bearing elements, which are located between the bearing ring and the fuselage surface, such that the bearing ring is rotatable around the fuselage.

For providing the above described fixation of the wing arrangement to the fuselage by the sleeve, according to a further exemplary embodiment, the aircraft comprises a first fixing element (e.g. a first bolt) and a second fixing element (e.g. a second bolt). The sleeve comprises an elongated through hole, which may have an extension approximately parallel to the fuselage axis. The first fixing element and the second fixing element are coupled, e.g. in a rotatable manner, spatially apart from each other to one of the wing arrangements. The first fixing element is further coupled to the sleeve and the second fixing element is further coupled through the elongated through hole to the fuselage or the bearing ring, respectively. The first fixing element and the second fixing element may be for example a first bolt and a second bolt or a first wing spar and a second wing spar of the respective wing arrangement, respectively. Respective first ends of the first and second fixing elements are for example rotatably coupled to a root section of the respective wing arrangement. The opposed ends of the respective first and second fixing elements are for example rotatably coupled to the sleeve and rotatably fixed to the fuselage or the bearing ring.

The second fixing element which couples the respective wing arrangement to the fuselage or the bearing ring forms a pivot point through which the respective longitudinal wing axis (i.e. a wing rotary axis) of the respective wing arrangement runs. The respective wing arrangement is thus rotatable around the pivot point.

For example, if the sleeve is moved along the surface of the fuselage or the bearing ring, e.g. along the fuselage axis, the first fixing element (e.g. bolt) moves together with the sleeve, whereas the second fixing element (e.g. bolt) which is fixed to the fuselage or the bearing ring does not move along the further rotary axis. Hence, by moving the sleeve and hence the first fixing element along the fuselage, the respective wing arrangement pivots around the pivot point, e.g. around its respective longitudinal wing axis. The tilting of the respective wing arrangement around the longitudinal wing axis and hence the movement of the sleeve along the bearing ring or the fuselage, respectively, may be initiated by a control force, which may be generated by e.g. servo motors or mechanical mechanism.

By the above described fixing mechanism for the respective wing arrangements to the fuselage, a robust mechanism for the tilting of respective wing arrangements is formed.

In particular, the first fuselage part may function as the above-described sleeve. In other words, the first fuselage part and the sleeve may be integrally formed.

Furthermore, the first wing arrangement, the second wing arrangement and the first fuselage part, the second fuselage part and the propulsion unit may be detachably attached to each other so that an aircraft kit is provided which is easy to transport and which can be reassembled in a fast manner. Furthermore, due to the modular design, defect parts may be substituted very simple.

Furthermore, according to a further exemplary embodiment, the aircraft comprises a swash plate which is coupled to the fuselage. The first wing arrangement and/or the second wing arrangement are coupled to the swash plate. The swash plate is movable with respect to the fuselage axis in a controllable manner, such that the orientation and the location of the respective first wing arrangement and/or the second wing arrangement with respect to the fuselage axis are amendable. Hence, by controlling the swash plate, a flight control of the aircraft in particular in the hover flight mode is achievable. By adjusting the orientation and the location of the respective first wing arrangement and/or the second wing arrangement with respect to the fuselage axis, a forward movement of the aircraft in the hover flight mode is realizable.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this application.

### BRIEF DESCRIPTION OF THE DRAWINGS

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

FIG. 1 shows an exemplary embodiment of the aircraft, wherein the aircraft is shown in a fixed wing flight mode;

FIG. 2 shows a further exemplary embodiment of the aircraft which is shown in a hover flight mode;

FIG. 3 shows an exemplary embodiment of the aircraft which is shown in the hover flight mode and which comprises a third wing arrangement functioning as a landing gear;

FIG. 4 shows a top view of an exemplary embodiment of the aircraft which is shown in the hover flight mode;

FIG. 5 shows an exemplary embodiment of the aircraft which is shown in the fixed wing flight mode;

FIG. 6 shows a schematical view of a coupling mechanics for coupling the wing arrangement to the fuselage according to an exemplary embodiment of the present invention; and

FIG. 7 shows a schematical view of a flight control system for the aircraft according to an exemplary embodiment of the present invention.

### DESCRIPTION OF EXEMPLARY EMBODIMENTS

The illustration in the drawing is schematically. It is noted that in different figures, similar or identical elements are provided with the same reference signs.

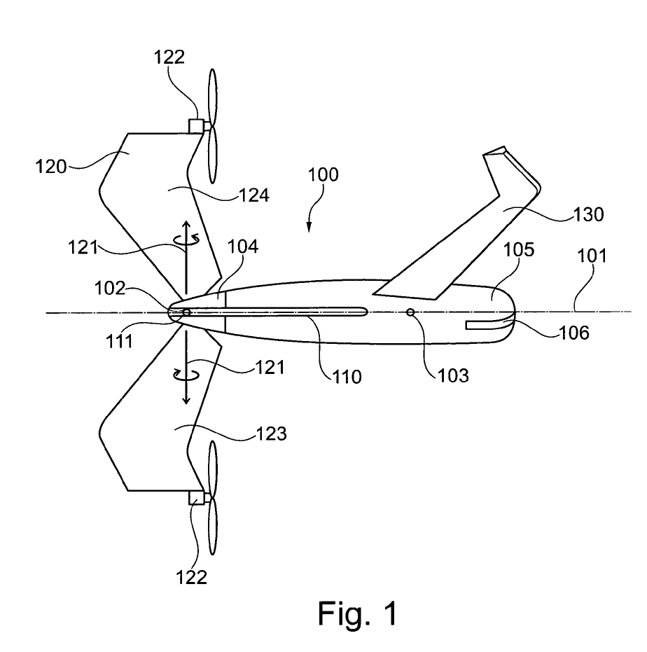

FIG. 1 shows an aircraft which comprises a fuselage 100 having a fuselage axis 101, a first wing arrangement 110 and a second wing arrangement 120. The first wing arrangement 110 is mounted to the fuselage 100 such that the first wing arrangement 110 is tiltable around a first longitudinal wing axis 111 of the first wing arrangement 110 and such that the first wing arrangement 110 is rotatable around the fuselage axis 101.

The second wing arrangement 120 comprises at least one propulsion unit 122, wherein in particular the first wing arrangement 110 is free of any propulsion units 122. The second wing arrangement 120 is mounted to the fuselage 100 such that the second wing arrangement 120 is tiltable around a second longitudinal wing axis 121 of the second wing arrangement 120 and such that the second wing arrangement 120 is rotatable around the fuselage axis 101.

The first wing arrangement 110 and the second wing arrangement 120 are adapted in such a way that, in a fixed wing flight mode (as shown e.g. in FIG. 1) the first wing arrangement 110 and the second wing arrangement 120 do not rotate around the fuselage axis 101.

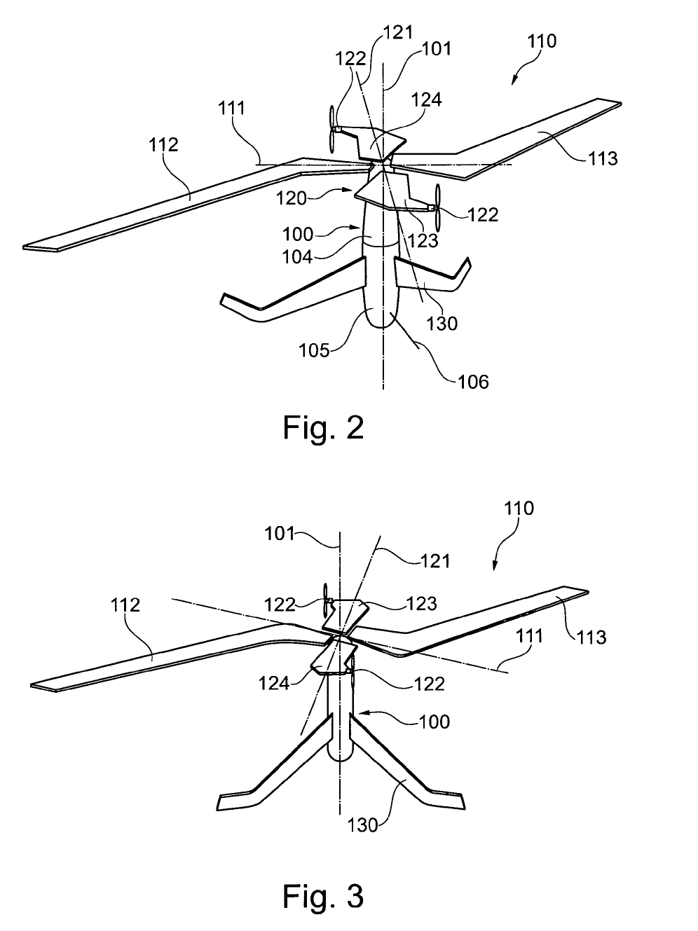

Furthermore, the first wing arrangement 110 and the second wing arrangement 120 are further adapted in such a way that, in a hover flight mode (as shown e.g. FIG. 2), the first wing arrangement 110 and the second wing arrangement 120 are tilted around the respective first longitudinal wing axis 111 and the respective second longitudinal wing axis 121 with respect to its orientations in the fixed wing flight mode and that the first wing arrangement 110 and the second wing arrangement 120 rotate around the fuselage axis 101.

In the exemplary embodiment in FIG. 1, the fuselage 100 comprises a first fuselage part 104 and a second fuselage part 105 which are arranged one after another along the fuselage axis 101.

The first wing arrangement 110 comprises a first wing 112 and a further first wing 113 (see FIG. 2). The first wing 112 and the further first wing extend from the fuselage along a first longitudinal wing axis 111. In particular, the first wing 112 and the further first wing 113 are tiltable around the first longitudinal wing axis 111. Specifically, the first longitudinal wing axis 111 is split in a first longitudinal wing axis section and a further first longitudinal wing axis section, wherein the first wing 112 extends along the first longitudinal wing axis section from the fuselage 100 and the further first wing 113 extends along the further first longitudinal wing axis section from the fuselage 100.

Accordingly, the second wing arrangement 120 comprises a second wing 123 and a further second wing 124. The second wing 123 and the further second wing 123 are tiltable around the second longitudinal wing axis 121 as indicated by the arrows. Specifically, the second longitudinal wing axis 121 is split in a second longitudinal wing axis section and a further second longitudinal wing axis section, wherein the second wing 123 extends along the second longitudinal wing axis section from the fuselage 100 and the further second wing 124 extends along the further second longitudinal wing axis section from the fuselage 100.

As shown in the exemplary embodiment of FIG. 1, the first longitudinal wing axis 111 and the second longitudinal wing axis 121 comprise an angle between each other of approximately 90°. Alternatively, the angle between the first longitudinal wing axis 111 and the second longitudinal wing axis 121 may be in the range between approximately 60° and 120°.

Furthermore, in an exemplary embodiment each of the wing arrangements 110, 120 may comprise three or more wings which are rotatable around respective longitudinal wing axes.

Furthermore, as shown in FIG. 1, the first wing arrangement 110 and the second wing arrangement 120 are attached to the first fuselage part 104, and in particular to a free end of the first fuselage part 104. The first fuselage part 104 comprises a first length along the fuselage axis 101 and the second fuselage part 105 comprises a second length along the fuselage axis 101. Specifically, the first length of the first fuselage part 104 is smaller than the second length of the second fuselage part 105. More specifically, the first length of the first fuselage part 104 is smaller than ⅙ or smaller than 1/10 of the second length of the second fuselage part 105.

A third wing arrangement 130, which comprises for example two or more wings, is attached to a second fuselage part 105. The third wing arrangement 130 may generate lift when moving the aircraft through the air in the fixed wing flight modes and thus stabilize the aircraft during flight, e.g. like a v-canard configuration.

Furthermore, as shown in FIG. 1, the second wing 123 and the further second wing 124 comprise at its free ends the respective propulsion units 122. The propulsion units 122 generate thrust in order to drive the aircraft through the air in the fixed wing flight mode. Furthermore, the second wing arrangement 120, and in particular the second wing 123 and the further second wing 124, may be tiltable around the respective second longitudinal wing axis 121 by a control unit, such that the second wing arrangement may function as a rudder for controlling the aircraft during flight in the fixed wing flight mode. It is also possible to use all wings of the wing arrangements (2 longer wings of the first wing arrangement 110 and 2 shorter wings of the second wing arrangement 120 (which functions as vertical stabilizers)) as ailerons. Therefore, a shift mechanism which controls the configuration from the fixed wing mode to the hover flight mode can be used.

Furthermore, at a nose section of the fuselage 100, and in particular as shown in FIG. 1 at a free end of the second fuselage part 105, a landing gear 106, which is extendable and foldable for example, is applied in order to provide a standing of the aircraft on a ground.

Furthermore, as shown in FIG. 1, the first wing arrangement 110 and the second wing arrangement 120 are mounted at a first mounting location 102 and a second mounting location 102 to the fuselage. In the exemplary embodiment in FIG. 1, the first mounting location 102 and the second mounting location 102 are located at the same location with respect to the fuselage axis 101. In other exemplary embodiments, the first location 102 and the second location 102 may be spaced apart along the fuselage axis 101. The third wing arrangement 130 is mounted to the fuselage at a third mounting location 103, wherein the third mounting location 103 is spaced from the first mounting location 102 and the second mounting location 102 along the fuselage axis 101.

FIG. 2 shows an exemplary embodiment of the aircraft in a hover flight mode.

The orientation of the first wing arrangement 110 and the second wing arrangement 120 differs to the orientation of the first wing arrangement 110 and the second wing arrangement 120 as shown in FIG. 1. Specifically, the first wing arrangement 110 is tilted around the first longitudinal wing axis 111 and the second wing arrangement 120 is rotated around the second longitudinal wing axis 121. In particular, the propulsion units 122 drive the first wing arrangement 110 and the second wing arrangement 120 in such a way, that the first wing arrangement 110 and the second wing arrangement 120 rotate around the fuselage axis 101. Due to the rotation of the respective wing arrangements 110, 120 around the fuselage axis 101, lift is generated such that the aircraft is operable in the hover flight mode, e.g. such as a helicopter.

Therefore, the first wing arrangement 110 and the second wing arrangement 120 are coupled e.g. to the first fuselage part 104. The first fuselage part 104 is rotatable around the fuselage axis 101.

On the other side, the second fuselage part 105, which is coupled rotatably to the first fuselage part 104, does not rotate. Hence, the aircraft may stand by the landing gear 106 on a ground, although the first fuselage part 104 and the respective first and second wing arrangements 110, 120 rotate. As shown in FIG. 2, the third wing arrangement 130 is mounted to the second fuselage part 105 and does not rotate around the fuselage axis 101.

FIG. 3 shows also the aircraft in the hover flight mode as shown in FIG. 2. Additionally, the third wing arrangement 130 as shown in FIG. 3 is formed in such a way, that the third wing arrangement 130 may function as a landing gear. Therefore, the sweep of the respective wings of the third wing arrangement 130 is variable and amendable such that in a configuration as shown in FIG. 3, the aircraft may stand on the ground by the third wing arrangement 130.

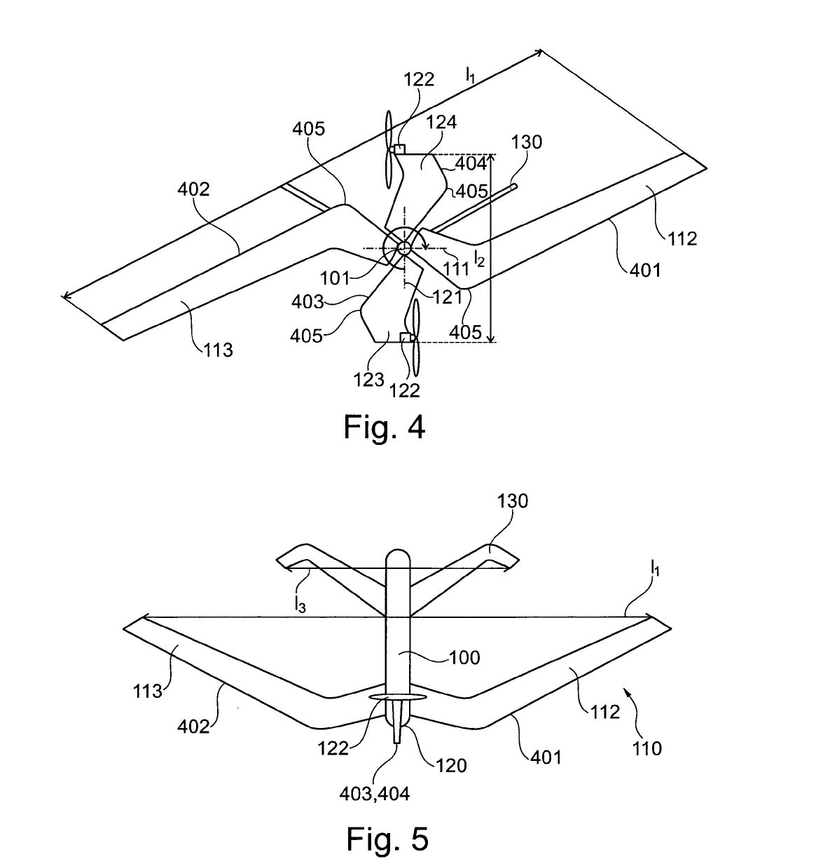

FIG. 4 shows a top view of the aircraft which is configured in the hover flight mode. The first wing arrangement 110 and the second wing arrangement 120 are coupled together, in particular to the first fuselage part 104, such that a thrust of the propulsion units 122 which are mounted to the second wing arrangement 120 drives the first wing arrangement 110 and the second wing arrangement 120 around the fuselage axis 101.

In FIG. 4, the first wing arrangement 110 comprises the first wing 112 and the second wing 113. The first wing 112 comprises a first leading edge 401 and the further first wing 113 comprises a further first leading edge 402. The second wing arrangement 120 comprises the second wing 123 and the further second wing 124. The second wing 123 comprises a second leading edge 403 and the further second wing 124 comprises a further second leading edge 404.

As can be taken from FIG. 4, the respective wings 112, 113, 123, 124 of the respective wing arrangements 110, 120 are tilted around its respective longitudinal wing axis 111, 112 in such a way that the respective leading edges 401, 402, 403, 404 are directed in the rotational direction. The leading edges 401, 402, 403, 404 are the edges of the wing which first contacts the air in comparison to other parts of the respective wings.

Furthermore, as can be taken from FIG. 4, the first wing arrangement 110 comprises a first wingspan 11 and a second wing arrangement 120 comprises a second wingspan 12. The wingspan 11, 12 is the distance from one wing tip to the other wing tip of a respective wing arrangement. Particularly, the wingspan is the distance from one free end (wing tip) to the other free end (wing tip) of the wing arrangement, wherein one free end is located relative to a first side of the fuselage and the other free end is located relative to an opposed side of the fuselage with respect to the first side.

As can be taken from FIG. 4, the second wingspan 12 of the second wing arrangement 120 is shorter than the first wingspan 11 of the first wing arrangement 110. The second wing arrangement 120 and its respective second wing 123 and further second wing 124 are formed robust, such that at their free ends (wing tips) the respective propulsion units 122 are mountable. In particular, due to the short second wingspan 12, the propulsion units 122 are located closer to the fuselage axis 101 than further propulsion units which would be mounted at free ends of the first wing arrangement 110. Hence, centrifugal forces which are generated during rotations of the wing arrangements 110, 120 around the fuselage axis 101 in the hover flight modes to the propulsion units 122 are reduced. Specifically, the propulsion units 122 comprise engine units and propeller units for generating thrust, wherein the engine units generate a driving torque for the respective propeller units. The engine unit may be coupled by a respective shaft to a respective propeller unit. Hence, the heavier engine units may be located at the second wing arrangement closer to the fuselage than the more lightweight propeller units, which are located farther away from the fuselage than the respective engine unit. Hence, the centrifugal forces which are generated by the mass of the engine units and the distance to the fuselage axis are kept small.

In comparison to the second wing arrangement 120, the first wing arrangement 110 comprises a larger first wingspan 11 and hence larger first wings 112 and further first wings 113 in comparison to the second wing arrangement 120. Hence, a higher aerodynamical lift may be generated by the first wing arrangement 110 in comparison to the second wing arrangement 120. More in particular, the aerodynamical area of the first wing arrangement 110 is larger than the aerodynamical area of the second wing arrangement 120.

FIG. 5 shows an exemplary embodiment of an aircraft as shown in FIGS. 1 to 4, wherein in FIG. 5 a fixed wing flight mode configuration in a bottom view is shown.

A gimbal is positioned in the front of the fuselage 100. Therewith, in combination with the upwards mounting of the third wing arrangement 130, a maximum viewing angle, which is not disturbed by any wings, is achieved.

The wings 112, 113, 123, 124 of the respective wing arrangements 110, 120 are tilted around its respective longitudinal wing axis 111, 121 such that the respective leading edges 401, 402, 403, 404 are directed in flight direction and are the parts of the wings 112, 113, 123, 124 which first contact the air when the aircraft moves through the air. Furthermore, the third wing arrangement 130 which is mounted to the fuselage 100 is shown. In particular, FIG. 5 shows that the first wing span I1 is larger than the third wing span I3 of the third wing arrangement 130, but can also be equal or even smaller. Modifying this will always change the position of the centre of Gravity as well as the hover flight capabilities.

Furthermore, as shown in particular in the top views of the Aircrafts in FIG. 4 and FIG. 5, the wings 112, 113, 123, 124 may have a run between its root ends and its free ends, which run is unsteadily and which run comprises a buckle 405, in particular at the respective leading edges 401, 402, 403, 404.

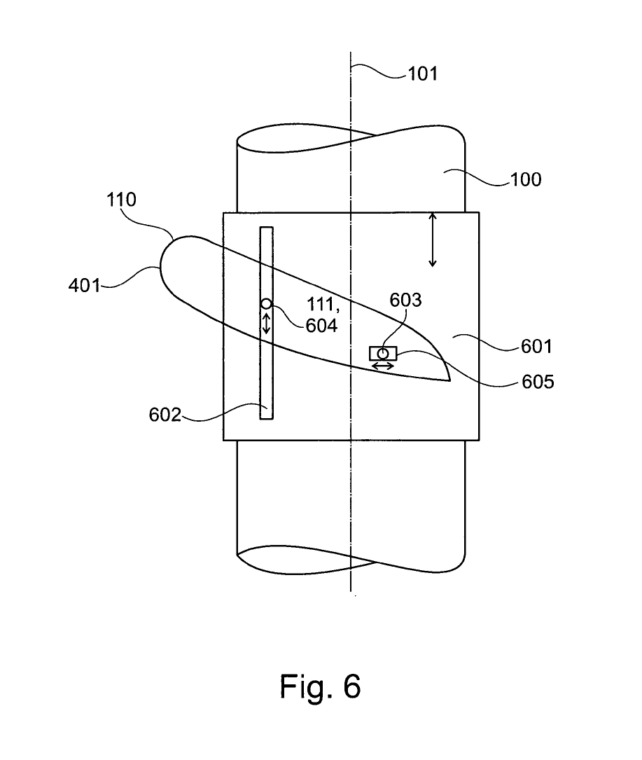

FIG. 6 shows an exemplary mounting mechanism for mounting the first wing arrangement 110 to the fuselage 100 such that the first wing arrangement 110 is tiltable around the first longitudinal wing axis 111 and such that the first wing arrangement 110 is rotatable around the fuselage axis 101.

The first wing arrangement 110 is attached to the fuselage 100 by interposing a sleeve 601 and optionally by a bearing ring. A first fixing element 603, such as a first fixing bolt, couples the first wing arrangement 110 to the sleeve 601. The second fixing element 604, such as a second bolt, couples the wing arrangement 110 through an elongated through hole 602 of the sleeve 601 to the fuselage 100 or to the bearing ring, respectively.

The pivoting axis (i.e. the first longitudinal wing axis 111) of the respective first wing arrangement 110 (and i.e. the respective wings 112, 113) is defined particularly by the second fixing element 604 which couples the respective first wing arrangement 110 rotatably to the fuselage 100 or to the bearing ring, respectively.

The first fixing element 603 may be fixed within a guiding slot 605 of the sleeve 601, such that during the tilting of the wing arrangement 110 around the second fixing element 604, the first fixing element 603 may slide along the guiding slot 605 in order to prevent a blockage of the tilting of the wing arrangement 110. The guiding slot may have a circumferential extension around the fuselage axis 101.

Hence, if the sleeve 601 is moved along the sliding direction (e.g. parallel with the fuselage axis 101) with respect to the fuselage 100 or to the bearing ring, respectively, the first fixing element 603 is moved as well along the fuselage 100 and in particular along the fuselage axis 101, wherein the second fixing element 604 does not change its position along the fuselage axis 101 because it is fixed to the fuselage 100 or to the bearing ring, respectively. Hence, by sliding the sleeve 601 along the fuselage axis 101, a tilting of the wing arrangement 110 around the second fixing element 604 is achieved.

The sliding of the sleeve 601 along the fuselage 100 or along the bearing ring, respectively, and thus along the fuselage axis 101 may be initiated by a control device, such as a servo motor.

The second wing arrangement 120 may be mounted by respective further first and second fixing elements to the sleeve 601 as described above for the first wing arrangement 110. Alternatively, the second wing arrangement 120 may be mounted by respective further first and second fixing elements to a further sleeve in a manner as described above for the coupling of the first wing arrangement 110 to the sleeve 601. The sleeve 601 and the further sleeve may be coupled, so that a driving torque may be transferred from the further sleeve to the sleeve and vice versa. Furthermore, the sleeve 601 may be in an exemplary embodiment the first fuselage part 104 which rotates with respect to the second fuselage part 105.

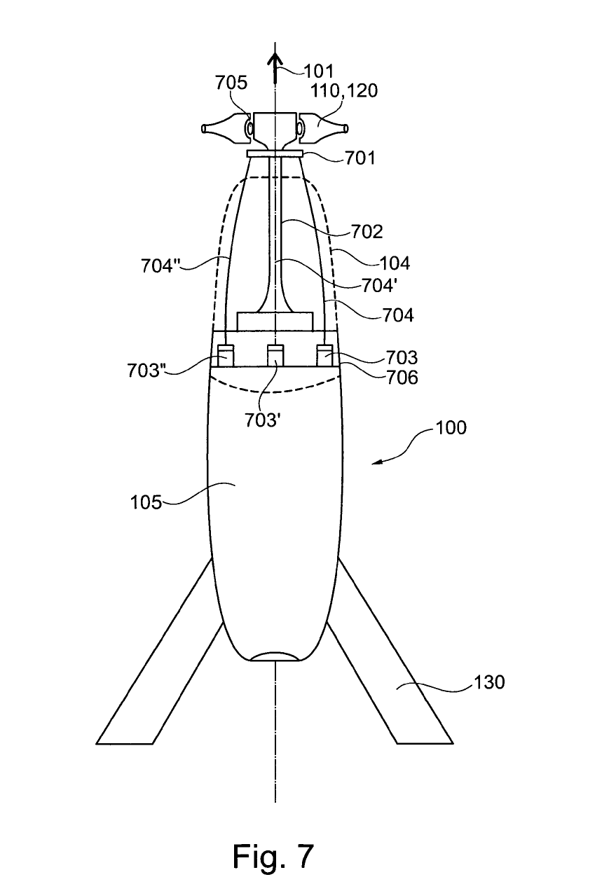

FIG. 7 shows a flight control system for the aircraft. Specifically, the aircraft comprises a swash plate 701 which is coupled to the fuselage 101 by a rod 702. The rod 702 is elastically bendable or is coupled to the fuselage 101, specifically to a base 706 of the fuselage 101, by a hinge. The rod 702 is coupled with a first end to the base 706 of the fuselage 101. To a second end of the rod 702, which is located oppositely to the first end of the rod 702, the first and/or second wing arrangement 110, 120 is coupled to the rod 702. The first and/or second wing arrangement 110, 120 is coupled to the rod 702 by e.g. a roller bearing 705, such that the respective first and/or second wing arrangement 110, 120 is rotatable around the rod 702 e.g. in the hover flight mode.

The base 706 may be in particular a part of the second fuselage part 105 and is thus non-rotatable in the hover flight mode. The rotatable first fuselage part 104 is shown in FIG. 7 with dotted lines. In particular, the first fuselage part 104 houses the rod 702 for example.

Furthermore, respective first ends of ropes 704, 704′, 704″ are coupled to the swash plate 701 and respective second ends of the ropes 704, 704′, 704″ are coupled to respective servo motors 703, 703′, 703″ which are installed on the base 706. The first ends of the ropes 704, 704′, 704″ are spaced apart from each other along a circumference around the swash plate 701.

Hence, by controlling the respective servo motors 703, 703′, 703″, the respective lengths of the respective ropes 704, 704′, 704″ is amendable, such that an orientation and a location the swash plate 701 and the respective second end of the rod 702 with respect to the fuselage axis 101 is amendable and controllable. Hence, also the orientation and the location of the first and/or second wing arrangement 110, 120 with respect to the fuselage axis 101 is controllable.

Hence, by the above described configuration, a control system for the aircraft in the hover flight mode is provided. Due to the orientation and the location of the first and/or second wing arrangement 110, 120 with respect to the fuselage axis 101, a forward movement of the aircraft in the hover flight mode or a stabilization of the aircraft in the hover flight mode is achieved. In particular, between the second end of the rod 702 and the first and/or second wing arrangement 110, 120 the sleeve 601 as described in FIG. 6 may be interposed, such that the control system of FIG. 7 and the coupling mechanics as described in FIG. 6 are combinable. The respective fixing elements 603, 604 are then fixed to the sleeve 601 and to the second end of the rod 702, respectively.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

### LIST OF REFERENCE SIGNS

100 fuselage

101 fuselage axis

102 first location, second location

103 third location

104 first fuselage part

105 second fuselage part

106 landing gear

110 first wing arrangement

111 first longitudinal wing axis

112 first wing

113 further first wing

120 second wing arrangement

121 second longitudinal wing axis

122 propulsion unit

123 second wing

124 further second wing

130 third wing arrangement

401 first leading edge

402 further first leading edge

403 second leading edge

404 further second leading edge

405 buckle

601 sleeve

602 elongated through hole

603 first fixing element

604 second fixing element

605 guiding slot

701 swash plate

702 rod

703 servo motor

704 rope

705 roller bearing

706 base

I1 first wingspan

I2 second wingspan

I3 third wingspan

1-20. (canceled)

21. An aircraft, comprising:
a fuselage comprising a fuselage axis;
a first wing arrangement which is mounted to the fuselage such that the first wing arrangement is tiltable around a first longitudinal wing axis of the first wing arrangement and such that the first wing arrangement is rotatable around the fuselage axis; and
a second wing arrangement which comprises at least one propulsion unit,
wherein the second wing arrangement is mounted to the fuselage such that the second wing arrangement is tiltable around a second longitudinal wing axis of the second wing arrangement and such that the second wing arrangement is rotatable around the fuselage axis, and
wherein the first wing arrangement and the second wing arrangement are adapted in such a way that, in a fixed-wing flight mode, the first wing arrangement and the second wing arrangement do not rotate around the fuselage axis, and
wherein the first wing arrangement and the second wing arrangement are further adapted in such a way that, in a hover flight mode, the first wing arrangement and the second wing arrangement are tilted around the respective first longitudinal wing axis and the respective second longitudinal wing axis with respect to its orientations in the fixed-wing flight mode and that the first wing arrangement and the second wing arrangement rotate around the fuselage axis.

22. The aircraft according to claim 21,
wherein the first wing arrangement comprises a first wingspan,
wherein the second wing arrangement comprises a second wingspan, and
wherein the first wingspan is longer than the second wingspan.

23. The aircraft according to claim 22,
wherein the second wingspan is shorter than the half of the first wingspan, in particular shorter than one third of the first wingspan.

24. The Aircraft according to claim 21,
wherein the first wing arrangement is free of any propulsion units.

25. The aircraft according to claim 21,
wherein the second wing arrangement comprises controllable control surfaces such that the second wing arrangement is adaptable for the use as a rudder in the fixed wing mode.

26. The aircraft according to claim 21,
wherein the first wing arrangement is mounted to the fuselage at a first mounting location, and
wherein the second wing arrangement is mounted to the fuselage at a second mounting location.

27. The aircraft according to claim 26,
wherein the first mounting location and the second mounting location are spaced apart with respect to each other along the fuselage axis.

28. The aircraft according to claim 26,
wherein the first mounting location and the second mounting location are not spaced apart along the fuselage axis.

29. The aircraft according to claim 26, further comprising:
a third wing arrangement,
wherein the third wing arrangement is mounted to the fuselage at a third mounting location, and
wherein the third location is spaced to the first mounting location and the second mounting location along the fuselage axis.

30. The aircraft according to claim 21,
wherein the fuselage comprises a first fuselage part and a second fuselage part,
wherein the first fuselage part and the second fuselage part are arranged one after another along the fuselage axis, and
wherein the first wing arrangement and the second wing arrangement are mounted to the first fuselage part.

31. The aircraft according to claim 30,
wherein the first fuselage part is rotatable around the fuselage axis with respect to the second fuselage part.

32. The aircraft according to claim 30,
wherein the second fuselage part comprises a landing gear, in particular an extendible landing gear.

33. The aircraft according to claim 21, further comprising:
a first hinge device; and
a second hinge device,
wherein the first wing arrangement is mounted to the fuselage by the first hinge device and the second wing arrangement is mounted to the fuselage by the second hinge device, such that the first wing arrangement and the second wing arrangement are foldable between an operating mode of the aircraft and a transportation mode of the aircraft.

34. The aircraft according to claim 21,
wherein the first wing arrangement comprises a first wing and a further first wing,
wherein the first longitudinal wing axis is split in a first longitudinal wing axis section and a further first longitudinal wing axis section,
wherein the first wing extends along the first longitudinal wing axis section from the fuselage and the further first wing extends along the further first longitudinal wing axis section from the fuselage,
wherein the first wing is tiltable with a first rotary direction around the first longitudinal wing axis section,
wherein the further first wing is tiltable with a further first rotational direction around the further first longitudinal wing axis section, and
wherein in particular the first rotational direction differs to the further first rotational direction.

35. the aircraft according to claim 21,
wherein the second wing arrangement comprises a second wing and a further second wing,
wherein the second longitudinal wing axis is split in a second longitudinal wing axis section and a further second longitudinal wing axis section,
wherein the second wing extends along the second longitudinal wing axis section from the fuselage and the further second wing extends along the further second longitudinal wing axis section from the fuselage,
wherein the second wing is tiltable with a second rotary direction around the second longitudinal wing axis section,
wherein the further second wing is tillable with a further second rotational direction around the further second longitudinal wing axis section, and
wherein in particular the second rotational direction differs to the further second rotational direction.

36. The aircraft according to claim 21,
wherein the propulsion unit comprises a turbo jet engine, a turbofan engine, a turboprop engine, a propfan engine and/or a propeller engine.

37. The aircraft according to claim 21, further comprising:
a sleeve to which at least one of the first wing arrangement and the second wing arrangement is mounted; and
a bearing ring which is interposed between the sleeve and the fuselage,
wherein the sleeve and the bearing ring are rotatable mounted to the fuselage such that the sleeve and the bearing ring are rotatable around the fuselage axis, and
wherein the sleeve is slideable along the bearing ring for adjusting a tilting angle of the at least one of the first wing arrangement and the second wing arrangement.

38. The aircraft according to claim 37, further comprising:
a first fixing element and a second fixing element,
wherein the sleeve comprises an elongated through hole,
wherein the first fixing element and the second fixing element are coupled spatially apart from each other to the at least one of the first wing arrangement and the second wing arrangement,
wherein the first fixing element is further coupled to the sleeve, and
wherein the second fixing element is further coupled through the elongated through hole to the bearing ring.

39. The aircraft according to claim 21, further comprising:
a swash plate which is coupled to the fuselage,
wherein the first wing arrangement and/or the second wing arrangement are coupled to the swash plate, and
wherein the swash plate is movable with respect to the fuselage axis in a controllable manner, such that the orientation and the location of the respective first wing arrangement and/or the second wing arrangement with respect to the fuselage axis is amendable.

40. A method of controlling an aircraft for vertical take-off and landing according to claim 21, the method comprising:
converting the aircraft in a fixed-wing flight mode by arranging the first wing arrangement, the second wing arrangement and the fuselage with respect to each other such that the fixed-wing flight is enabled; and
converting the aircraft in the hover flight mode:
by tilting the first wing arrangement around the first longitudinal wing axis;
by tilting the second wing arrangement around the second longitudinal wing axis; and
by rotating the first wing arrangement and the second wing arrangement around a fuselage axis for enabling the hover flight.
